(19) United States
(12) Patent Application Publication
(10) Pub. No.: US 2018/0205617 A1
(43) Pub. Date: Jul. 19, 2018

(54) SYSTEM AND METHOD FOR GRAPHICALLY BUILDING A VIRTUAL NETWORK OF COMPUTER COMPONENTS

(71) Applicant: BOOZ ALLEN HAMILTON INC., McLean, VA (US)

(72) Inventors: Eric Winterton, Severn, MD (US); Daniel Hunter, Round Hill, VA (US); Allen Norman, Glen Burnie, MD (US); Eli Kahn, Silver Spring, MD (US)

(73) Assignee: BOOZ ALLEN HAMILTON INC., McLean, VA (US)

(21) Appl. No.: 15/641,812

(22) Filed: Jul. 5, 2017

Related U.S. Application Data
(60) Provisional application No. 62/445,927, filed on Jan. 13, 2017.

(51) Int. Cl. H04L 12/24

(52) U.S. Cl. CPC H04L 41/145; G06F 3/0482

(57) ABSTRACT

A system for graphically building a virtual network of computer components, the system including: a processor device for receiving an input library of components to form a network, and for devising communication pathways among the components; a display for displaying a proposed interconnection of components; and a memory device for storing component characteristics, wherein the processor device will produce a visual display of the proposed network based on the components selected for inclusion in the network.

### CROSS-REFERENCE TO RELATED APPLICATIONS

This application claims the benefit of U.S. Provisional Application No. 62/445,927, filed on Jan. 13, 2017, the contents of which are incorporated herein by reference in their entirety.

### FIELD

The present disclosure relates to a system and method for graphically building a virtual network of computer components.

### BACKGROUND

Systems exist in which existing physical networks can be modeled or tested. However, there is a need for a system and method to graphically build a network that has not yet been created using graphical representations of network components, and to automatically and rapidly create a virtual network based on the graphically built network.

### SUMMARY

An exemplary embodiment of the present disclosure provides a system for graphically building a virtual network of computer components, the system including: a processor device for receiving an input library of components to form a network, and for devising communication pathways among the components; a display for displaying a proposed interconnection of components; and a memory device for storing component characteristics, wherein the processor device will produce a visual display of the proposed network based on the components selected for inclusion in the network.

An exemplary embodiment of the present disclosure provides a method for graphically building a virtual network of computer components. The method including: storing, on a memory device, an input library of components to form a network and characteristics of the components of the input library; selecting components for inclusion in the network; devising, by the processor device, communication pathways among the selected components; producing, by a processor device, a visual display of interconnections of the selected components in a proposed network based on the components selected for inclusion in the network; and displaying the interconnections of the selected components in the proposed network on a display.

### BRIEF DESCRIPTION OF THE DRAWINGS

The scope of the present disclosure is best understood from the following detailed description of exemplary embodiments when read in conjunction with the accompanying drawings.

FIG. 1A is a block diagram illustrating a system hardware architecture in accordance with an exemplary embodiment.

FIG. 1B is a block diagram illustrating a system hardware architecture in accordance with an exemplary embodiment.

FIG. 2 is a flow chart illustrating a method according to an exemplary embodiment.

FIG. 3A is a flow chart illustrating a method according to an exemplary embodiment.

FIG. 3B is a flow chart illustrating a method according to an exemplary embodiment.

FIG. 4 is a flow chart illustrating a method according to an exemplary embodiment.

FIG. 5 is a flow chart illustrating a method according to an exemplary embodiment.

FIG. 6 is a flow chart illustrating a method according to an exemplary embodiment.

FIG. 7 is a flow chart illustrating a method according to an exemplary embodiment.

FIG. 8 is a graphical user interface according to an exemplary embodiment.

FIG. 9 is a hardware architecture of a computing device according to an exemplary embodiment.

FIG. 10 is a flow chart illustrating a method according to an exemplary embodiment.

FIG. 11 is a flow chart illustrating a method according to an exemplary embodiment.

### DETAILED DESCRIPTION

The present disclosure is directed to a system and method of generating a virtual network based on a graphical user interface (e.g., Microsoft Visio, etc.) in which users can intuitively drag-and-drop graphical representations of network components (workstations, servers, routers, different sub-nets, etc.) to create a notional network, and then auto-deploy and generate this notional network within a virtual environment (e.g., a virtual server or servers) in a matter of minutes. Examples of the virtual environment include VMware vSphere, Amazon Web Services, Google Cloud, any virtualization platform that has an API, etc.

The virtual network generated in the virtual environment can be used, for example, to run tests on the generated virtual network (e.g., cyber security tests/training). As a graphical user interface can be used to position graphical representations of components relative to each other and connect them together, a virtual network that has not yet been created can be easily and rapidly designed.

Prior systems model existing networks and are text-based or form-based and use point-and-click functionality, they do not use the dragging and dropping of graphical network components. Also, graphical representations of these networks are static and not clickable. The present system and method results in a ninety percent increase in efficiency by reducing the workload to create the virtual network due to the graphical designing of the network and the automation of the establishment of a virtual network. In an exemplary embodiment, the system can create complex virtual enterprise environments that are instantiations of emulated customer networks/enterprises.

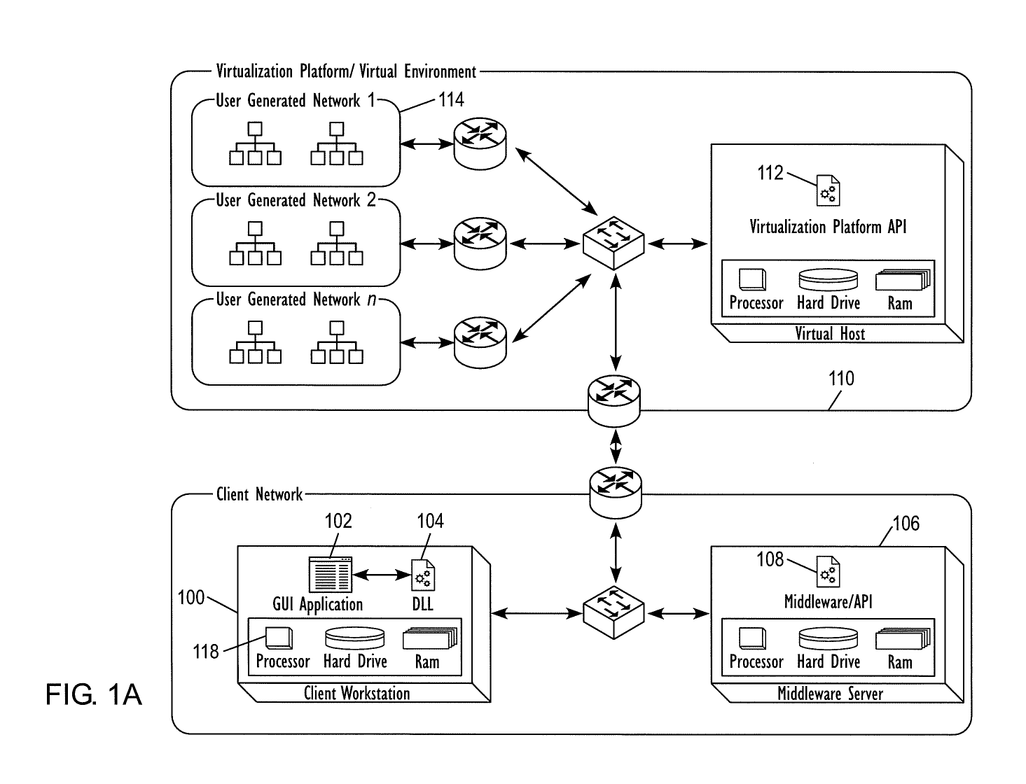

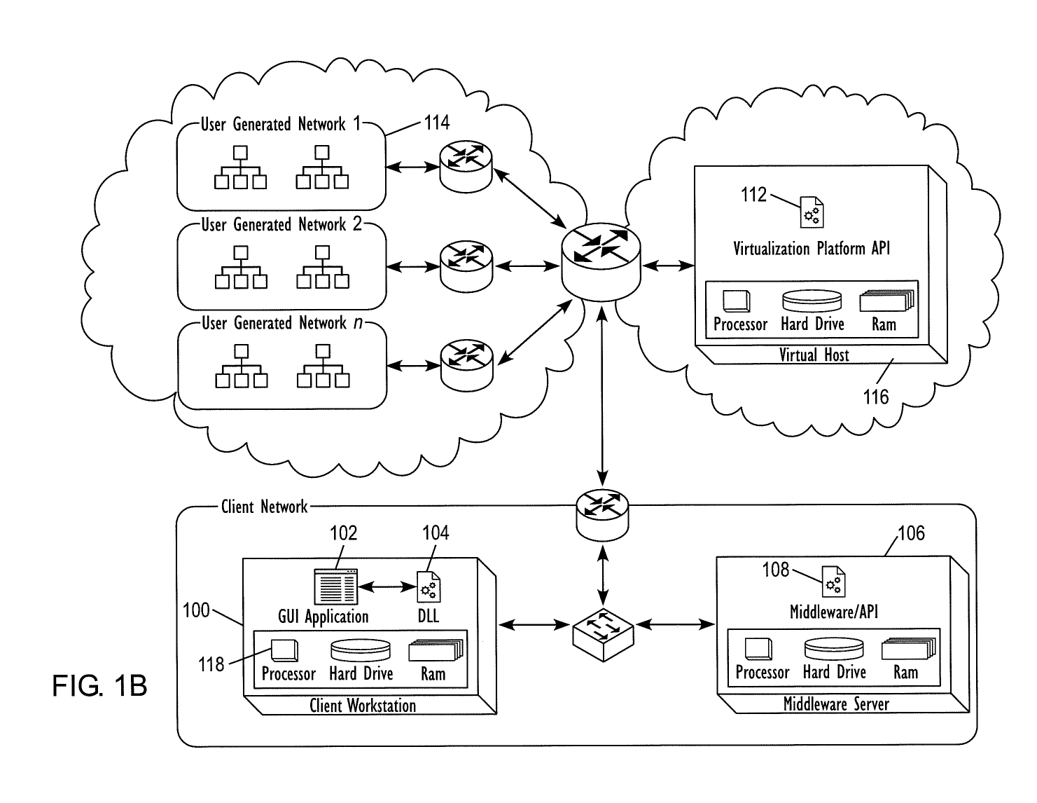

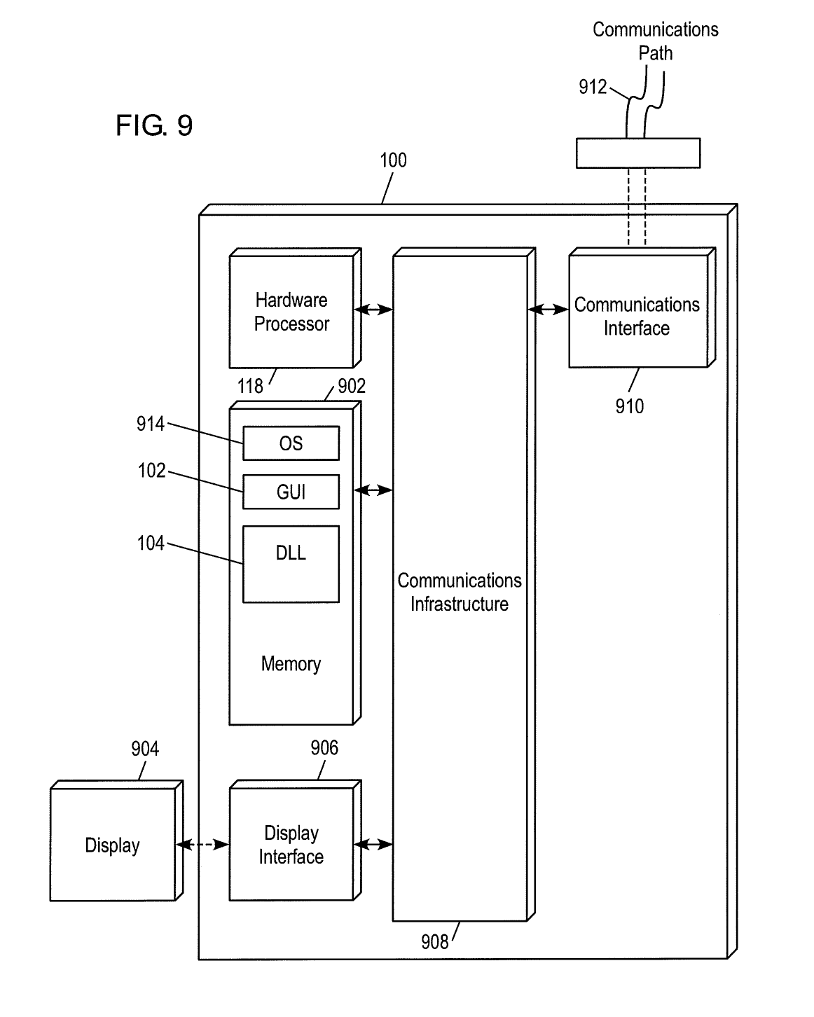

FIG. 1A is a block diagram illustrating a system for graphically building a virtual network 114 of computer components for possible implementation as a physical network at a future point in time. In a non-limiting embodiment, a physical network can be created based on the generated virtual network. The system includes a computing device 100 such as a client workstation, a middleware server 106, and a virtual environment (i.e. virtualization platform) 110. The computing device 100 includes a processor device 118 for receiving an input library of components to form a network, and for devising communication pathways among the components. The computing device 100 also includes a display 904 for displaying a proposed interconnection of components, and a memory device (e.g., hard drive, RAM, etc.) for storing component characteristics (shown in FIG. 9). The processor device 118 will produce a visual display of the proposed network based on the components selected for inclusion in the network.

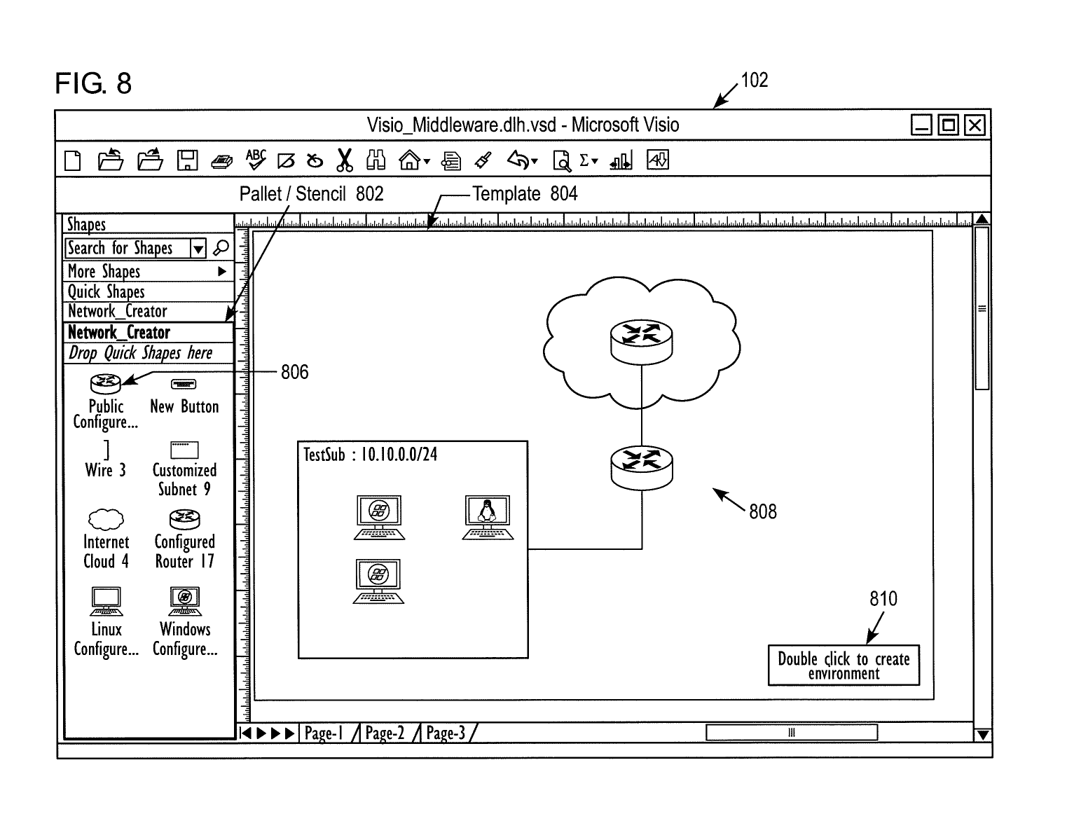

In FIG. 1A, the computing device 100 also includes a graphical user interface (hereinafter “GUI”) 102 that has access to the input library of components, and by which components are displayed and selected for inclusion in the network by moving graphical representations of the components from a first area (e.g., a pallet 802) into a second area (e.g., a template 804). See FIG. 8. The computing device 100 can also include a dynamic link library (DLL) that the GUI 102 can access to receive information regarding network components that can be chosen from within the GUI 102.

The system of FIG. 1A also includes a middleware device 106 (e.g., middleware server) that includes a processor, one or more memory devices, and middleware/API 108. The middleware device 106 and/or middleware/API 108 are configured to receive at least one request from the GUI 102 for data about the selected components of the proposed network. FIG. 1A shows the client network including the computing device 100 and the middleware device 106; however the components and/or functions of the computing device 100 and the middleware device 106 could be present in one computing device. The computing device 100, the middleware device 106, and the virtual environment can communicate with each other by sending or receiving data through routers and/or switches as shown in FIG. 1A.

The system of FIG. 1A also includes a virtual environment 110 which generates a virtual network 114 based on the proposed network created by the GUI 102 in the computing device 100. The virtual environment 110 includes a processor, at least one memory device (e.g., memory, RAM, etc.), and a virtualization platform API 112. The virtual environment 110 also includes the virtual networks 114.

FIG. 1B, shows similar components to FIG. 1A, but shows a cloud computing architecture. In FIG. 1B, a virtual host 116 is present on the cloud, and the virtual host includes the virtualization platform API 112.

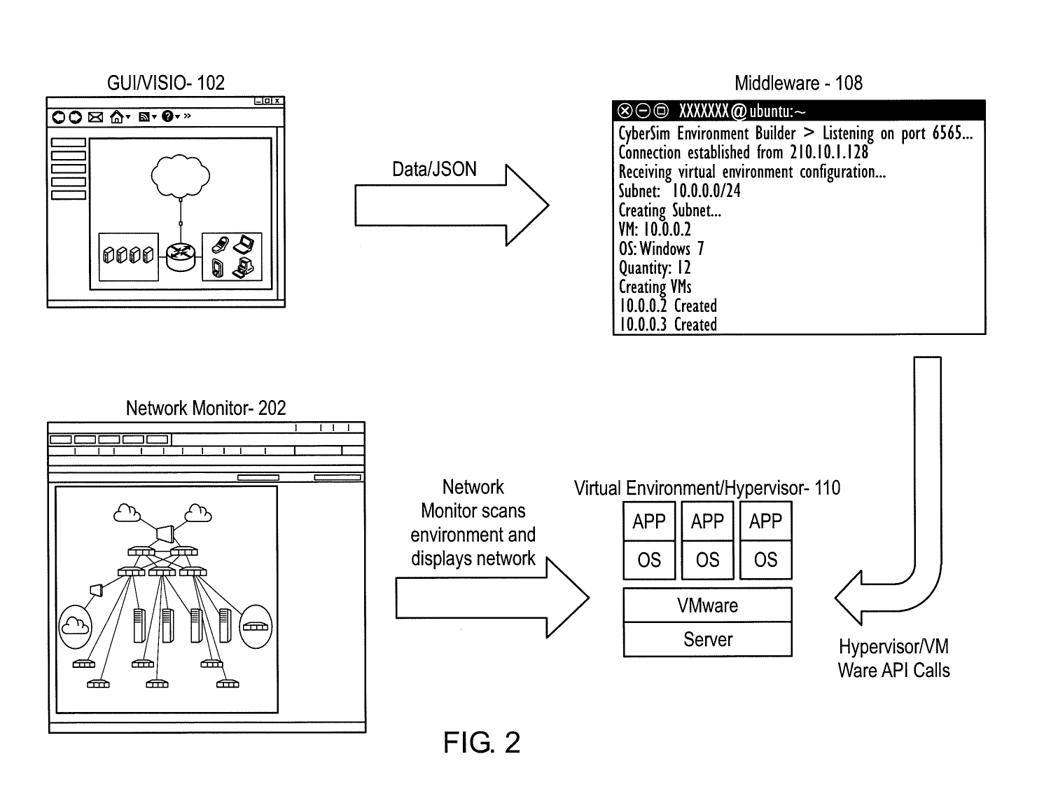

In the exemplary method of FIG. 2, a user 400 uses the GUI 102 to create the proposed network by dragging and dropping network components selected from a library of components, and data regarding the selected components is sent from the GUI 102 to the middleware device 106 where it is used by the middleware 108. The data sent between the GUI 102 and the middleware device 106 can be in the Java Script Object Notation (JSON) format, XML format, etc. The data sent to the middleware is used to process the design created in the GUI 102. The middleware device 106/middleware 108 is configured to send data regarding the selected components to the virtual environment 110 for the virtual environment 110 to generate the virtual network 114 (the virtual network is a representation of a physical network). In an exemplary embodiment shown in FIG. 2, the middleware 106 is configured to generate API calls based on the data from the GUI 102 (e.g., the JSON), and to send API calls to the virtual environment 110. After the API calls are sent to the virtual environment 110, the virtual environment contains the virtual network designed using the GUI 102. Optionally, in FIG. 2, a network monitor 202 may scan the virtual environment 110 or a physical network environment and display the network on the display 904, proving that the network has been created.

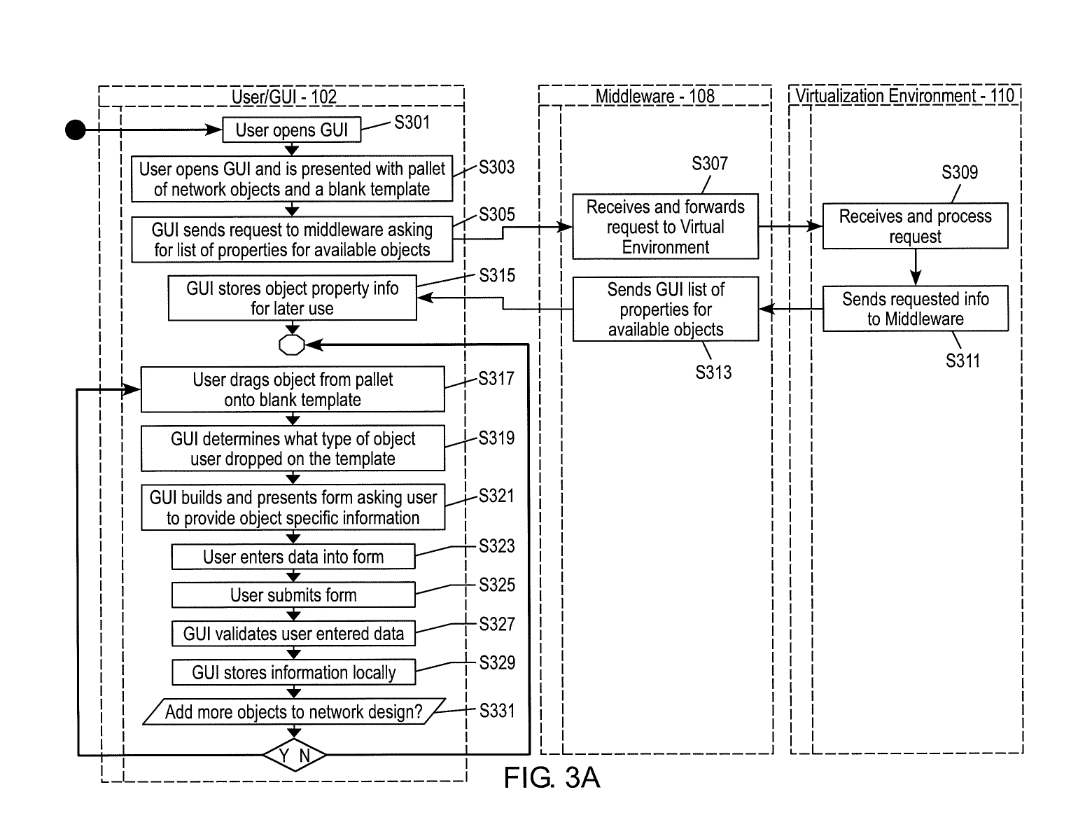

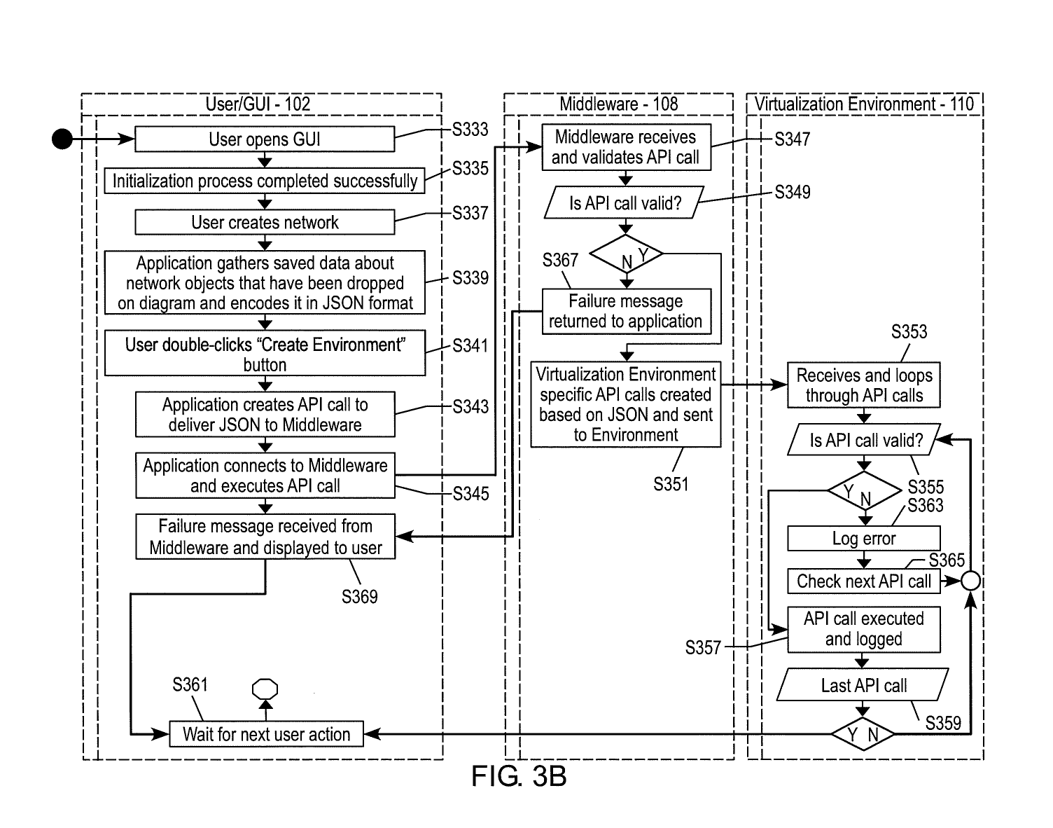

FIG. 3A illustrates an exemplary method of creating a virtual network on a virtual environment 110 using the GUI 102. In step S301, a user 400 opens the GUI 102. In step S303, after the GUI 102 is opened, the user 400 is presented with a pallet 802 (i.e., library of components) of network objects 806 (i.e., network components such as a server, client, router, etc.) and a blank template 804 where a proposed network 808 can be designed as shown in FIG. 8. In Visio, a pallet 802 is called a stencil. In step S305, the GUI 102 sends a request to the middleware 108 asking for a list of properties for available network objects 806. In step S307, the middleware 108 receives and forwards the request to the virtual environment 110. In step S309, the virtual environment 110 receives and processes the request. In step S311, the virtual environment 110 sends requested information to the middleware 108. In step S313, the middleware 108 sends the GUI 102 a list of properties for available objects (e.g., IP address, characteristic of the objects (e.g., type of operating system, etc.)). In step S315, the GUI 102 stores object property information for later use.

In step S317, the user 400 drags an object from the pallet 802 (shown in FIG. 8) onto the blank template 804 of the GUI 102. In step S319, the GUI 102 determines what type of object the user 400 dropped on the template 804. In step S321, the GUI 102 builds and presents a form that asks the user 400 to provide object specific information (e.g., IP address, etc.). In step S323, the user 400 enters data into the form. In step S325, the user 400 submits the form. In step S327, the GUI 102 validates the data entered by the user 400. In step S329, the GUI 102 stores the information locally, e.g., on the computing device 100. In step S331, the user 400 can add more objects to the network design by continuing to drag and drop objects from the pallet 802 onto the blank template 804.

FIG. 3B illustrates an exemplary method of creating a virtual network. In step S333, the user 400 opens the GUI 102. In step S335, an initialization process is successfully completed. In step S337, the user 400 creates a virtual network using objects 806 from the pallet 802 of the GUI 102 and drops them on to the template 804. In step S339, the GUI 102 (e.g., an application, etc.) gathers saved data about the network objects 806 that have been dropped on the template 804, and encodes the data in JSON format. In step S341, the user 400 double-clicks the “Create Environment” button 810. In step S343, the GUI 102 creates an API call to deliver the JSON to the middleware 108. In step S345, the GUI 102 connects to the middleware 108 and executes and API call. In step S347, the middleware 108 receives and validates the API call received from the GUI 102. In step S349, the middleware 108 determines whether the API call is valid. If it is determined that the API call is valid, in step S351, virtualization environment specific API calls are created by the middleware 108 based on JSON and sent to the virtualization environment 110. In step S353, the virtualization environment 110 receives and loops through the API calls, by processing through steps S355, S357, S359, S363, and S365. In step S355, the virtualization environment 110 determines whether a received API call is valid. If it is determined that the API call is valid, in step S357, the API call is executed and logged. In step S359, the virtualization environment 110 determines whether that was the last API call. If it is the last API call, the GUI 102 waits for the next user action in step S361. If it is not the last API call, the process proceeds to step S355, where it is determined whether the next received API call is valid. If an API call is not valid, in step S363, an error is logged. In step S365, the next API call is checked, and the process proceeds back to step S355 where it is determined whether an API call is valid.

In step S349, if it is determined that the API call is not valid, the process proceeds to step S367. In step S367, a failure message is returned to the GUI 102, and the process proceeds to step S369, where a failure message received from the middleware 108 is displayed to the user 400.

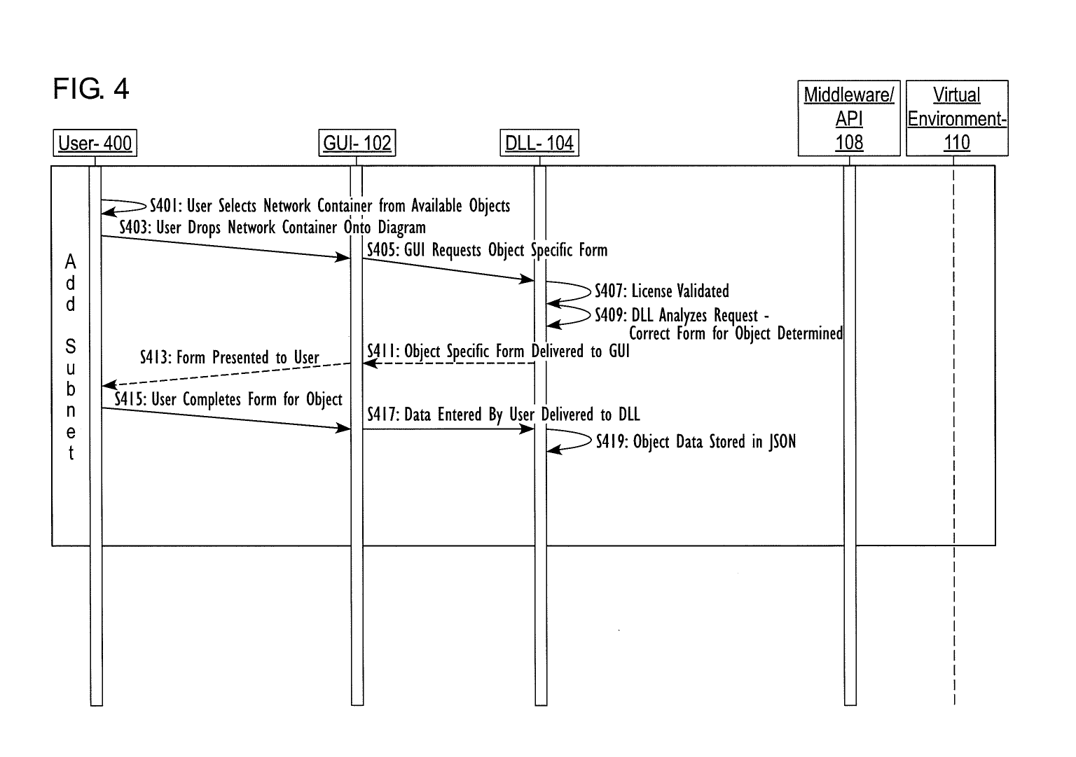

FIG. 4 illustrates an exemplary method of adding a subnet to a virtual network using the GUI 102. In step S401, the user 400 selects a network container from available objects 806 in the pallet 802. In step S403, the user 400 drops the selected network container onto the template 804. In step S405, the GUI 102 requests an object specific form from the DLL 104. In step S407, the DLL 104 validates a license. In step S409, the DLL 104 analyzes the request and the correct form for the object is determined. In step S411, the DLL 104 sends the object specific form to the GUI 102. In step S413, the form is presented to the user 400 on the GUI 102. In step S415, the user 400 completes the form for the object. In step S417, the data entered into the form by the user 400 is delivered to the DLL 104. In step S419, the DLL 104 stores the object data in JSON.

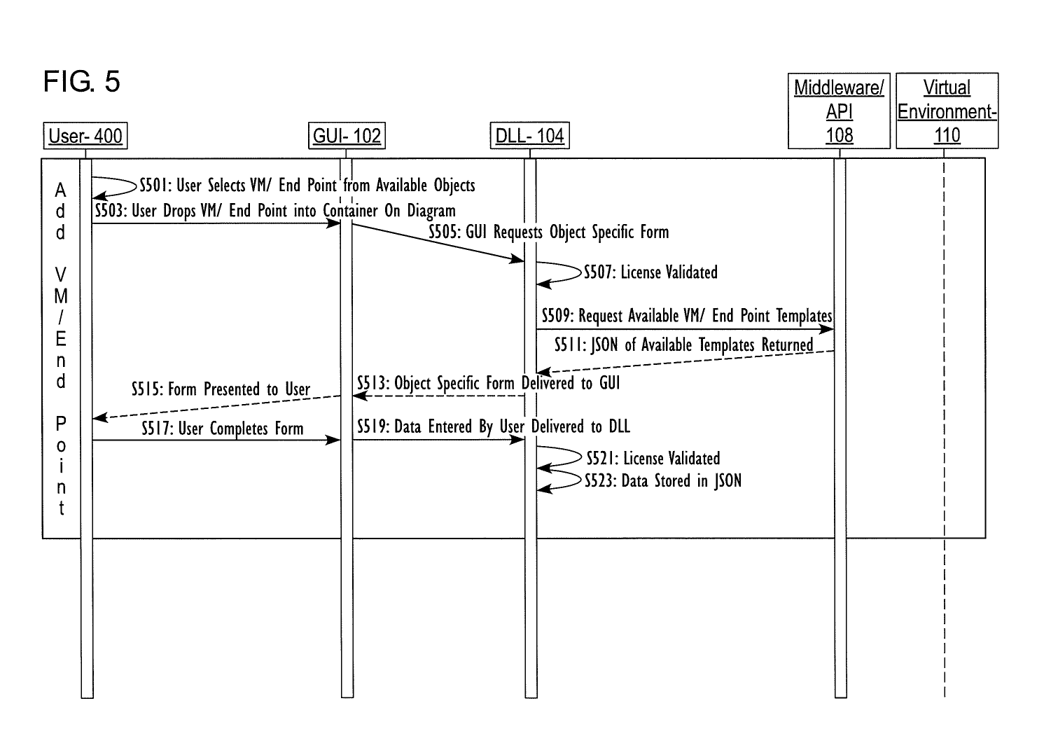

FIG. 5 illustrates an exemplary method of adding a virtual machine (VM)/endpoint using the GUI 102. In step S501, the user 400 selects the VM/endpoint from available objects 806 in the pallet 802. In step S503, the user 400 drops the VM/endpoint into a container on the template 804/diagram. In step S505, the GUI 102 requests an object specific form from the DLL 104. In step S507, the DLL 104 validates a license. In step S509, the DLL 104 requests templates for available VMs/endpoints from the middleware 108. In step S511, the middleware 108 returns JSON of available templates to the DLL 104. In step S513, the DLL 104 sends the object specific form to the GUI 102. In step S515, the form is presented to the user 400 on the GUI 102. In step S517, the user 400 completes the form for the object. In step S519, the data entered into the form by the user 400 is delivered to the DLL 104. In step S521, the DLL 104 validates a license. In step S523, the DLL 104 stores the data entered by the user 400 in JSON.

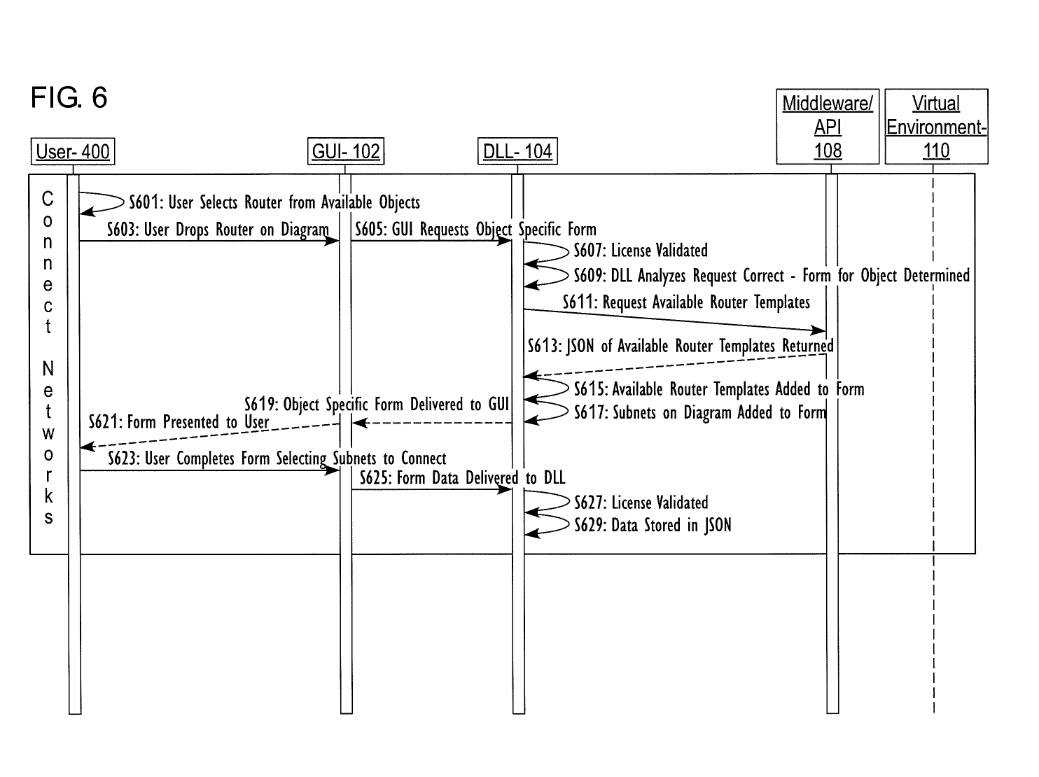

FIG. 6 illustrates an exemplary method of connecting networks using the GUI 102. In step S601, the user 400 selects a router from available objects 806 in the pallet 802. In step S603, the user 400 drags and drops the router on the template 804/diagram. In step S605, the GUI 102 requests an object specific form from the DLL 104. In step S607, the DLL 104 validates a license. In step S609, the DLL 104 analyzes the request, and determines the correct form for the object. In step S611, the DLL 104 requests available router templates from the middleware 108. In step S613, the middleware 108 returns JSON of available router templates to the DLL 104. In step S615, the available router templates are added to the form by the DLL 104. In step S617, subnets on the diagram are added to the form by the DLL 104. In step S619, the DLL 104 sends the object specific form to the GUI 102. In step S621, the form is presented to the user 400 on the GUI 102. In step S623, the user 400 completes the form by selecting the subnets to connect. In step S625, the data entered into the form by the user 400 is delivered to the DLL 104. In step S627, the DLL 104 validates a license. In step S629, the DLL 104 stores the data entered by the user 400 in JSON.

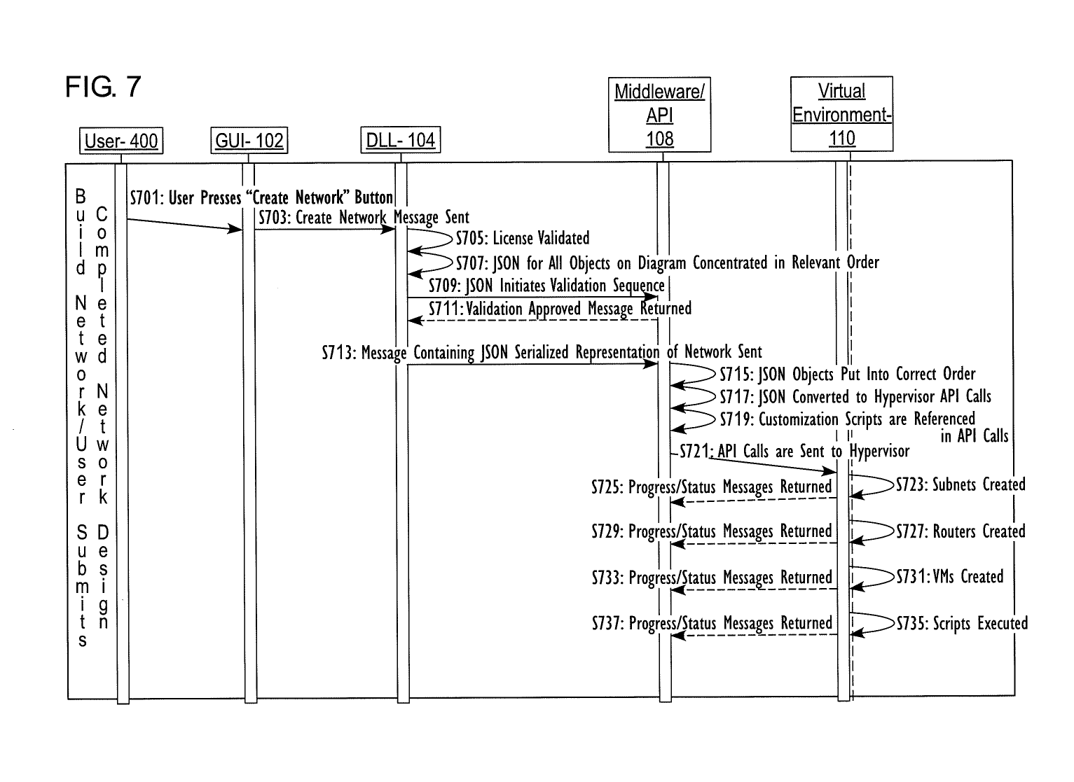

FIG. 7 illustrates an exemplary method of building a virtual network when the user 400 submits a completed network design. In step S701, the user 400 presses a “create network/environment” button 810 (shown in FIG. 8). In step S703, the GUI 102 sends a message that the network is created to the DLL 104. In step S705, the DLL 104 validates a license. In step S707, JSON for all objects on the template 804/diagram are concatenated in relevant order by the DLL 104. In step S709, JSON initiates a validation sequence by sending data from the DLL 104 to the middleware 108. In step S711, a validation approved message is returned to the DLL 104 from the middleware 108. In step S713, a message containing a JSON serialized representation of the network is sent from the DLL 104 to the middleware 108. In step S715, the middleware 108 puts JSON objects into the correct order. In step S717, the middleware 108 converts JSON to virtual environment/hypervisor API calls. In step S719, customization scripts are referenced in API calls. In step S721, API calls are sent from the middleware 108 to the virtual environment 110. In step S723, the virtual environment 110 creates subnets. In step S725, progress/status messages are returned to the middleware 108 from the virtual environment 110. In step S727, the virtual environment 110 creates routers. In step S729, progress/status messages are returned to the middleware 108 from the virtual environment 110. In step S731, the virtual environment 110 creates VMs. In step S733, progress/status messages are returned to the middleware 108 from the virtual environment 110. In step S735, the virtual environment 110 executes scripts. In step S737, progress/status messages are returned to the middleware 108 from the virtual environment 110.

FIG. 9 is a block diagram illustrating a computing device 100 architecture in accordance with an exemplary embodiment that could be used as the client workstation shown in FIG. 1. A similar computing device architecture could be used for the middleware server 106 and virtual environment 110. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A hardware processor device as discussed herein may be a single hardware processor, a plurality of hardware processors, or combinations thereof. Hardware processor devices may have one or more processor “cores.” The term “non-transitory computer readable medium” as discussed herein is used to generally refer to tangible media such as a memory device 902.

Various embodiments of the present disclosure are described in terms of this exemplary computing device 100. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Hardware processor 118 may be a special purpose or a general purpose processor device. The hardware processor device 118 may be connected to a communication infrastructure 908, such as a bus, message queue, network, multi-core message-passing scheme, etc. The network may be any network suitable for performing the functions as disclosed herein and may include a local area network (LAN), a wide area network (WAN), a wireless network (e.g., Wi-Fi), a mobile communication network, a satellite network, the Internet, fiber optic, coaxial cable, infrared, radio frequency (RF), or any combination thereof. Other suitable network types and configurations will be apparent to persons having skill in the relevant art. The computing device 100 may also include a memory 902 (e.g., random access memory, read-only memory, etc.), and may also include one or more additional memories. The memory 902 and the one or more additional memories may be read from and/or written to in a well-known manner. In an embodiment, the memory 902 and the one or more additional memories may be non-transitory computer readable recording media.

Data stored in the computing device 100 (e.g., in the memory 902) may be stored on any type of suitable computer readable media, such as optical storage (e.g., a compact disc, digital versatile disc, Blu-ray disc, etc.), magnetic tape storage (e.g., a hard disk drive), or solid-state drive. An operating system 914, one or more graphical user interfaces 102, and the DLL 104 can be stored in the memory 902. One or more of the graphical user interfaces 102, and a DLL 104 could be located external to the computing device 100, for example in another computing device or other computing devices.

In an exemplary embodiment, the data may be configured in any type of suitable database configuration, such as a relational database, a structured query language (SQL) database, a distributed database, an object database, etc. Suitable configurations and storage types will be apparent to persons having skill in the relevant art.

The computing device 100 may also include a communications interface 910. The communications interface 910 may be configured to allow software and data to be transferred between the computing device 100 and external devices. Exemplary communications interfaces 910 may include a modem, a network interface (e.g., an Ethernet card), a communications port, a PCMCIA slot and card, etc. Software and data transferred via the communications interface 910 may be in the form of signals, which may be electronic, electromagnetic, optical, or other signals as will be apparent to persons having skill in the relevant art. The signals may travel via a communications path 912, which may be configured to carry the signals and may be implemented using wire, cable, fiber optics, a phone line, a cellular phone link, a radio frequency link, etc.

Memory semiconductors (e.g., DRAMs, etc.) may be means for providing software to the computing device 100. Computer programs (e.g., computer control logic) may be stored in the memory 902. Computer programs may also be received via the communications interface 910. Such computer programs, when executed, may enable computing device 100 to implement the present methods as discussed herein. In particular, the computer programs stored on a non-transitory computer-readable medium, when executed, may enable hardware processor device 102 to implement the methods illustrated by FIGS. 2-7, 10, and 11, or similar methods, as discussed herein. Accordingly, such computer programs may represent controllers of the computing device 100. Where the present disclosure is implemented using software, the software may be stored in a computer program product or non-transitory computer readable medium and loaded into the mobile computing device 100 using a removable storage drive or communications interlace 910.

The computing device 100 may also include a display interface 906 that outputs display signals to a display unit 904, e.g., LCD screen, plasma screen, LED screen, DLP screen, CRT screen, etc.

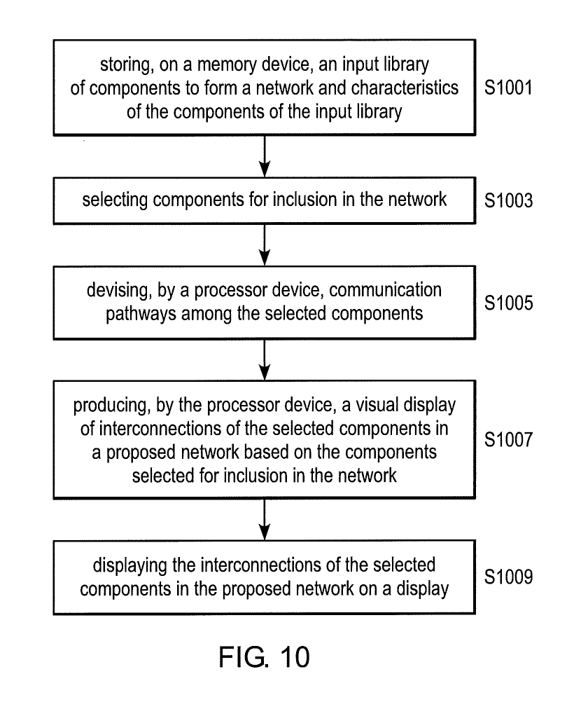

FIG. 10 illustrates an exemplary method for graphically building a virtual network of computer components. The method includes storing, on a memory device (e.g., memory device 902 of computing device 100), an input library of components to form a network and characteristics of the components of the input library (step S1001). The method includes selecting components for inclusion in the network (step S1003). The method includes devising, by the processor device 118, communication pathways among the selected components (step S1005). The method includes producing, by the processor device 118, a visual display of interconnections of the selected components in a proposed network based on the components selected for inclusion in the network (step S1007). The method includes displaying the interconnections of the selected components in the proposed network on the display 904 (step S1009).

In an exemplary embodiment, the method can include accessing the input library of components with the graphical user interface 102; displaying components of the input library in the graphical user interface 102; and selecting components for inclusion in the network by moving graphical representations of the components from a first area into a second area of the graphical user interface 102.

In an exemplary embodiment, the method can include receiving at least one request from the graphical user interface 102, using the middleware 106, for data about the selected components of the proposed network.

In an exemplary embodiment, the method can include generating, with the virtual environment 110, a virtual network 114 based on the proposed network. FIGS. 1A and 1B show, for example, several user generated networks 114.

In an exemplary embodiment, the method can include sending, by the middleware 106, data regarding the selected components to the virtual environment 110 for the virtual environment 110 to generate the virtual network 114.

In an exemplary embodiment, the method can include generating, by the middleware 106, API calls based on the data from the graphical user interface 108, and sending API calls to the virtual environment 110.

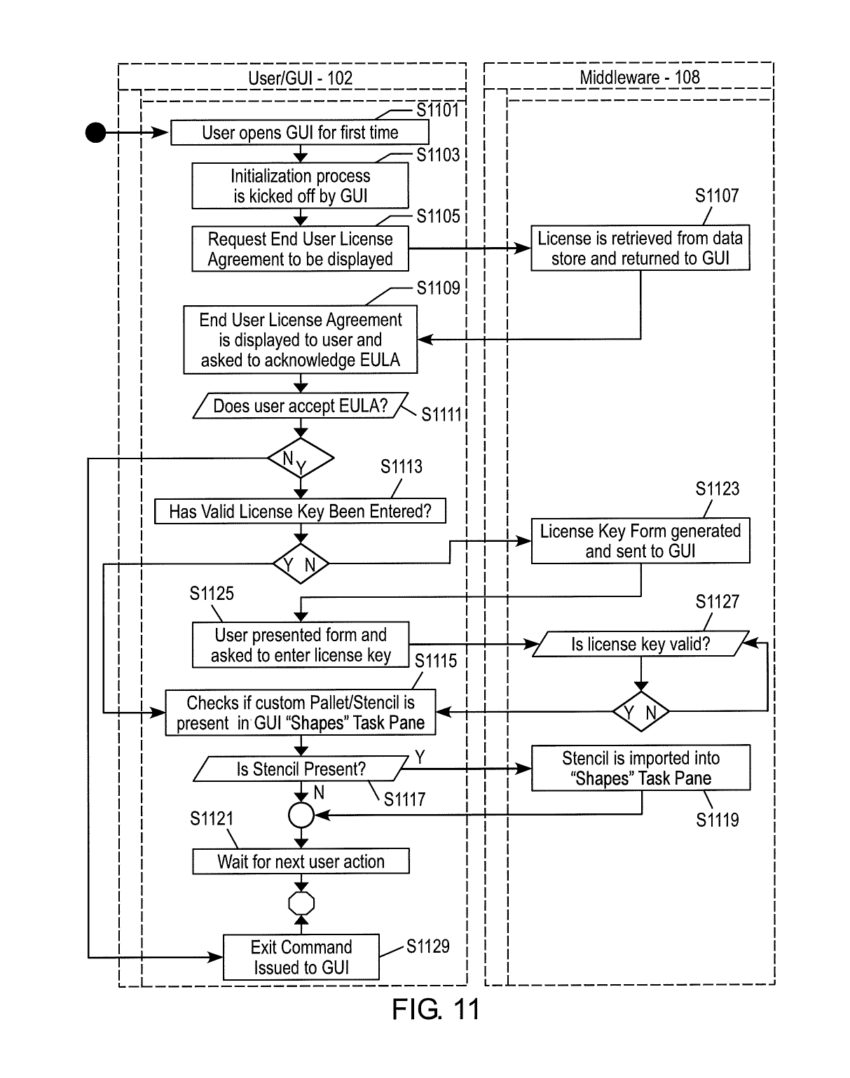

FIG. 11 illustrates an exemplary initialization process. In step S1101, the user 400 opens the GUI 102 for the first time. In step S1103, the GUI 102 starts the initialization process. In step S1105, the GUI 102 sends a request to the middleware 108 for an End User License Agreement (EULA) to be displayed. In step S1107, the middleware 108 retrieves the EULA from a data store and returns the EULA to the GUI 102. In step S1109, the GUI 102 displays the EULA to the user 400, and the user 400 is asked to acknowledge the EULA. In step S1101, the GUI 102 determines whether the user 102 has accepted the EULA. When it is determined by the GUI 102 that the user 400 has accepted the EULA, the GUI 102 determines whether a valid license key has been entered in step S1113. When it is determined by the GUI 102 that a valid license key has been entered, the GUI 102 checks if a custom pallet/stencil 802 is present in the GUI's “Shapes” Task Pane shown on the left side of GUI 102 in FIG. 8 (step S1115). In step S1117, the GUI 102 determines whether the stencil is present. If the GUI 102 determines that the stencil is present, the middleware 108 imports the stencil into the “Shapes” Task Pane of the GUI 102 (step S1119). In step S1121, the GUI 102 waits for the next user action.

In step S1113, when it is determined that a valid license key has not been entered, the middleware 108 generates a license key form and it is sent to the GUI 102 (step S1123). In step S1125, the GUI 102 presents a form to the user 400 and they are asked to enter the license key. The user 400 enters the license key, and in step S1127, the middleware 108 determines whether the license key is valid. If the middleware 108 determines that the license key is valid, the process proceeds to step S1115. If the middleware 108 determines that the license key is not valid, the process proceeds to step S1127.

In step S1113, if the user does not accept the EULA, an exit command is issued to the GUI 102, and the GUI 102 exits (i.e. closes).

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A system for graphically building a virtual network of computer components, the system comprising:
a processor device for receiving an input library of components to form a network, and for devising communication pathways among the components;
a display for displaying a proposed interconnection of components; and
a memory device for storing component characteristics, wherein the processor device will produce a visual display of the proposed network based on the components selected for inclusion in the network.

2. The system of claim 1, comprising:
a graphical user interface that has access to the input library of components, and by which components are displayed and selected for inclusion in the network by moving graphical representations of the components from a first area into a second area.

3. The system of claim 2, comprising:
middleware configured to receive at least one request from the graphical user interface for data about the selected components of the proposed network.

4. The system of claim 3, comprising:
a virtual environment which generates a virtual network based on the proposed network.

5. The system of claim 4, wherein the middleware is configured to send data regarding the selected components to the virtual environment for the virtual environment to generate the virtual network.

6. The system of claim 4, wherein the middleware is configured to generate API calls based on the data from the graphical user interface, and to send API calls to the virtual environment.

7. A method for graphically building a virtual network of computer components, the method comprising:
storing, on a memory device, an input library of components to form a network and characteristics of the components of the input library;
selecting components for inclusion in the network;
devising, by a processor device, communication pathways among the selected components;
producing, by the processor device, a visual display of interconnections of the selected components in a proposed network based on the components selected for inclusion in the network; and
displaying the interconnections of the selected components in the proposed network on a display.

8. The method of claim 7, comprising:
accessing the input library of components with a graphical user interface;
displaying components of the input library in the graphical user interface; and
selecting components for inclusion in the network by moving graphical representations of the components from a first area into a second area of the graphical user interface.

9. The method of claim 8, comprising:
receiving at least one request from the graphical user interface, using middleware, for data about the selected components of the proposed network.

10. The method of claim 9, comprising:
generating, with a virtual environment, a virtual network based on the proposed network.

11. The method of claim 10, comprising:
sending, by the middleware, data regarding the selected components to the virtual environment for the virtual environment to generate the virtual network.

12. The method of claim 10, comprising:
generating, by the middleware, API calls based on the data from the graphical user interface; and
sending the API calls to the virtual environment.
